(19) United States
(12) Patent Application Publication
(10) Pub. No.: US 2006/0238271 A1
(43) Pub. Date: Oct. 26, 2006

(54) Low temperature co-fired ceramic 90 degree power splitter

(76) Inventor: Alexander Dornhelm, Staten Island, NY (US)

Correspondence Address: KEVIN REDMOND, 6969 SW GATOR TRAIL, PALM CITY, FL, 34990, US

(21) Appl. No.: 11/112,383

(22) Filed: Apr. 25, 2005

(51) Int. Cl. H01P 5/12

(52) U.S. Cl. 333/128

(57) ABSTRACT

A power splitter that has a small package size and good electrical performance at frequencies less than 1 GHz. The power splitter includes a low temperature co-fired ceramic substrate that has several layers. A pair of transformers are formed by circuit lines that are interleaved on alternate layers. The circuit lines are connected between layers by vias. Capacitors are also formed on the layers.

### BACKGROUND

1. Field of the Invention

This invention relates to power splitters in general and more particularly to a 90 degree power splitter having a small package size.

2. Description of the Prior Art

Power splitters have been made by coupled transmission lines. The transmission lines are formed as micro-strip structures using printed circuit boards. Power splitters have also been fabricated on ceramic substrates using screened on thick film conductors and dielectrics. For low frequencies less than 1 GHz, implementing a power splitter in a ceramic package using coupled transmission lines requires long coupled transmission lines and a large area to accommodate the coupled lines.

Referring to FIG. 1, a schematic diagram of a prior art power splitter is shown. Power splitter 20 has an input port 21, an isolated port 24 and a pair of output ports 22 and 23. Coupled line 26 has one end connected to input port 21 and another end connected to output port 23. Coupled line 27 has one end connected to isolated port 24 and another end connected to output port 22.

Some power splitter applications have space constraints that require small package sizes. It is desirable for the power splitter to be as small as possible while still having the proper impedance and electrical characteristics.

While power splitters have been used, power splitters operating below 1 GHz have suffered from having a large package size due to the length of the coupled lines. A current unmet need exists for a low frequency power splitter that has a small package size.

### SUMMARY

It is a feature of the invention to provide a power splitter having a small package size that has good electrical performance at frequencies less than 1 GHz.

Another feature of the invention is to provide a power splitter that includes a low temperature co-fired ceramic substrate having a top surface, a bottom surface and a plurality of side surfaces. The substrate has layers including several inner layers. A first transformer is formed by a pair of circuit lines located on the inner layers. A first circuit line is interconnected between the layers by a first via. A second circuit line is interconnected between the layers by a second via. A second transformer is formed by a third and fourth circuit line located on the inner layers. The third circuit line is interconnected between the layers by a third via. The fourth circuit line is interconnected between the layers by a fourth via.

### BRIEF DESCRIPTION OF THE DRAWINGS

In order that the invention may be more fully understood, it will now be described, by way of example, with reference to the accompanying drawings in which:

FIG. 1 is a schematic diagram of a prior art power splitter.

FIG. 2 is a schematic diagram of a 90 degree power splitter using lumped elements in accordance with the present invention.

FIG. 3 is a perspective view of a low temperature co-fired ceramic 90 degree power splitter.

FIG. 4 is a top view of FIG. 3.

FIG. 5 is a bottom view of FIG. 3.

FIGS. 6A and 6B are an exploded view of FIG. 3 showing the patterned layers of low temperature co-fired ceramic. FIG. 6A illustrates the upper layers and FIG. 6B illustrates the lower layers.

FIG. 7 is an exploded view of FIG. 3 showing details of one of the transformers.

FIG. 8 is a graph of insertion loss versus frequency for the power splitter of FIG. 3 over the frequency range of 425 to 675 MHz.

FIG. 9 is a graph of VSWR versus frequency for the power splitter of FIG. 3 over the frequency range of 425 to 675 MHz.

FIG. 10 is a graph of isolation versus frequency for the power splitter of FIG. 3 over the frequency range of 425 to 675 MHz.

FIG. 11 is a graph of insertion loss versus frequency for the power splitter of FIG. 3 over the frequency range of 800 to 1400 MHz.

FIG. 12 is a graph of VSWR versus frequency for the power splitter of FIG. 3 over the frequency range of 800 to 1400 MHz.

FIG. 13 is a graph of isolation versus frequency for the power splitter of FIG. 3 over the frequency range of 800 to 1400 MHz.

It is noted that the drawings of the invention are not to scale. In the drawings, like numbering represents like elements between the drawings.

### DETAILED DESCRIPTION

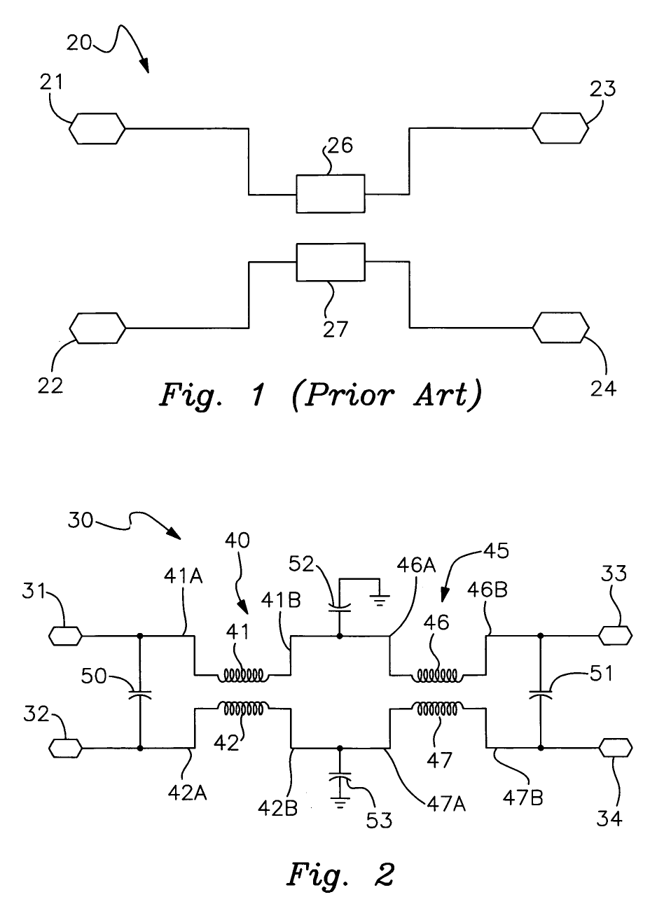

Referring to FIG. 2, a schematic diagram of a two way ninety degree power splitter using lumped elements in accordance with the present invention is shown. Power splitter 30 has an input port 31, an isolated port 34, and a pair of output ports 32 and 33.

Transformer 40 has windings 41 and 42. Winding 41 has ends 41A and 41B. Winding 42 has ends 42A and 42B. End 41A is connected to input port 31. End 42A is connected to output port 32.

Transformer 45 has windings 46 and 47. Winding 46 has ends 46A and 46B. Winding 47 has ends 47A and 47B. End 46A is connected to end 41B. End 46B is connected to output port 33. End 47A is connected to end 42B. End 47B is connected to isolated port 34.

Capacitor 50 is connected between input port 31 and output port 32. Capacitor 51 is connected between output port 33 and isolated port 34. Capacitor 52 is connected between the junction of ends 41B and 46A and ground. Capacitor 53 is connected between the junction of ends 42B and 47A and ground.

In FIG. 2, the power splitter is implemented using lumped elements instead of distributed elements such as coupled transmission lines. The output signals of power splitter 30 are ninety degrees out of phase from the input signal.

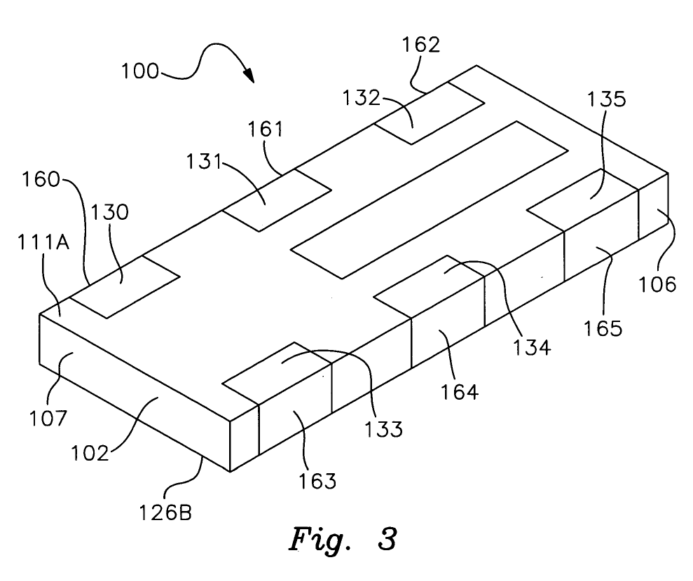

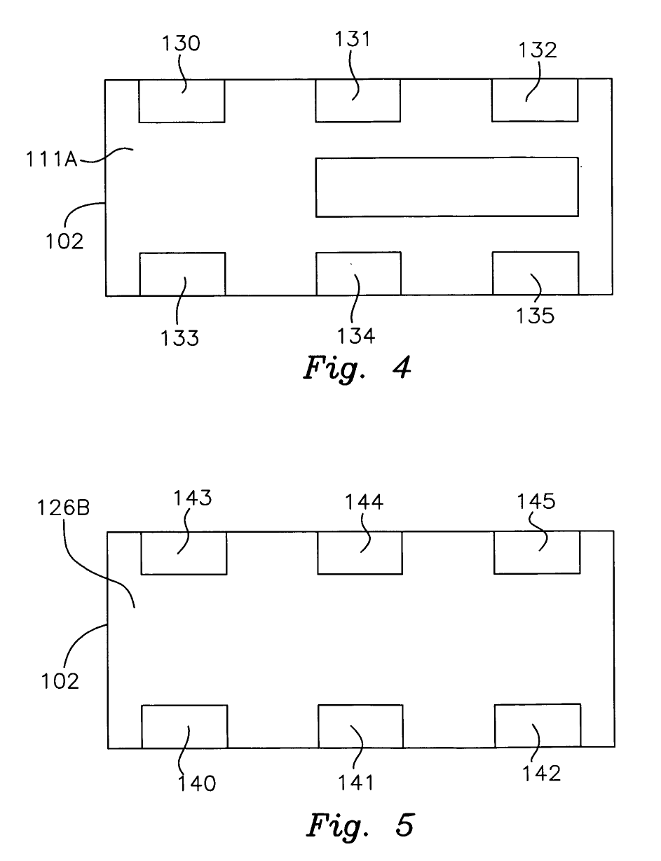

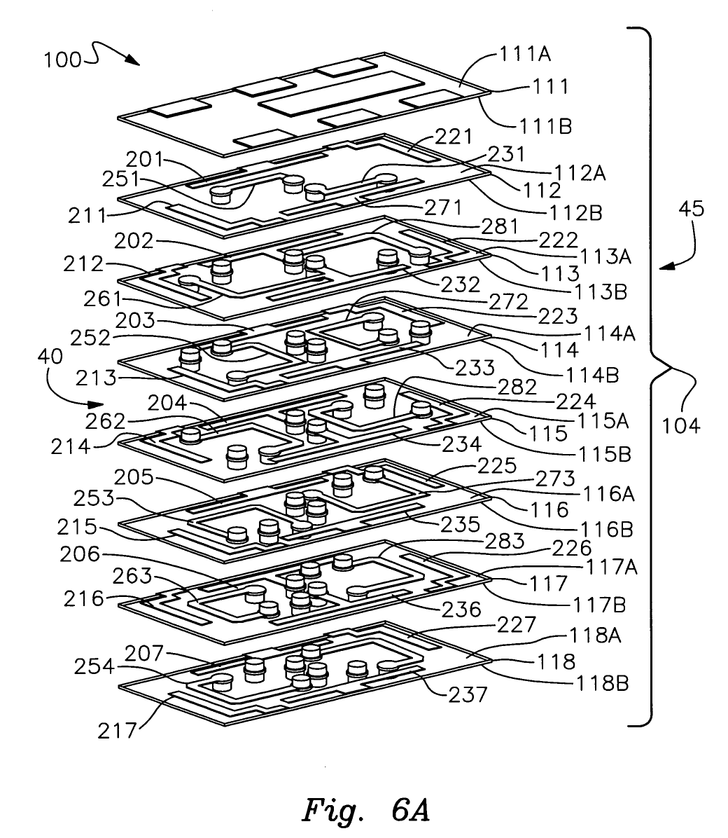

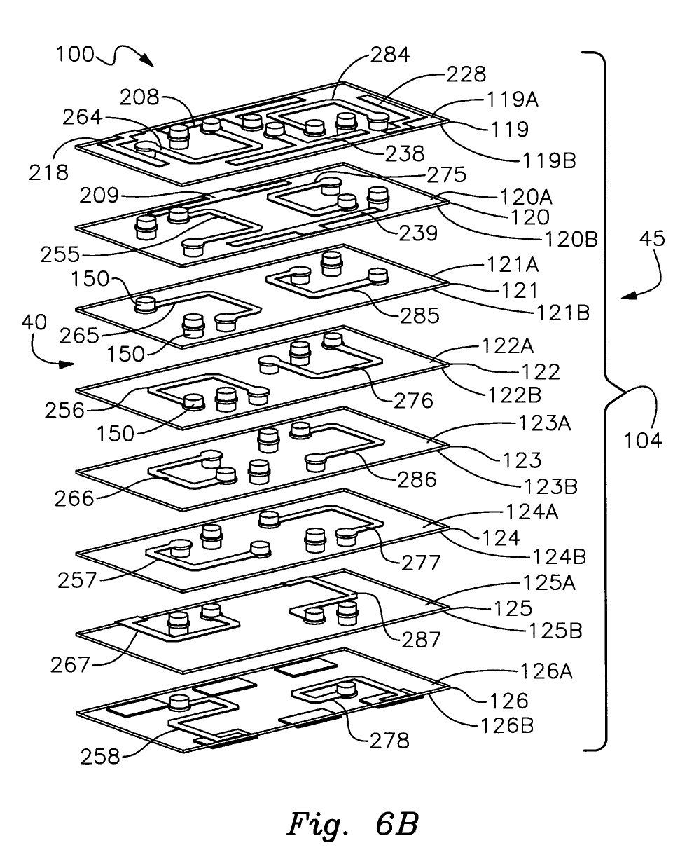

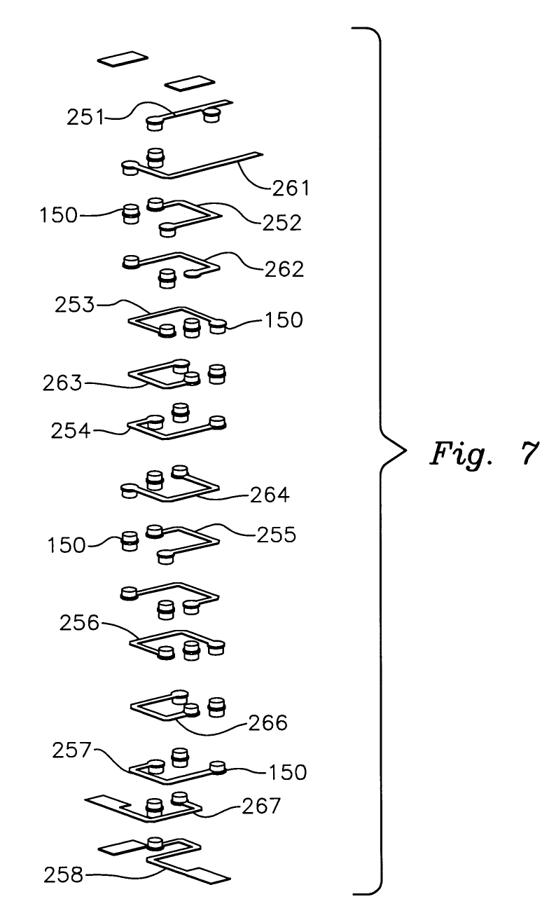

Referring to FIGS. 3-7, a physical implementation of the power splitter schematic of FIG. 2 in accordance with the present invention is shown. Power splitter 100 has a low temperature co-fired ceramic (LTCC) structure or substrate 102. Substrate 102 is comprised of multiple layers of LTCC material. There are sixteen LTCC layers in total including inner layers 104. Substrate 102 has side surfaces 106 and 107. Planar layers 111, 112, 113, 114, 115, 116, 117, 118, 119, 120, 121, 122, 123, 124, 125 and 126 are all stacked on top or adjacent to each other and form a unitary structure 102 after firing in an oven. LTCC layers 111-126 are commercially available in the form of a green unfired tape. Each of the layers has a top surface, 111A, 112A, 113A, 114A, 115A, 116A, 117A, 118A, 119A, 120A, 121A, 122A, 123A, 124A, 125A and 126A. Similarly, each of the layers has a bottom surface, 111B, 112B, 113B, 114B, 115B, 116B, 117B, 118B, 119B, 120B, 121B, 122B, 123B, 124B, 125B and 126B. The layers have several circuit features that are patterned on the top surfaces. Multiple vias 150 extend through each of the layers. Vias 150 are formed from an electrically conductive material and electrically connect the circuit features on one layer to the circuit features on another layer.

Layer 111 has several circuit features that are patterned on surface 111A. Surface 111A has terminals 130, 131, 132, 133, 134, and 135. Similarly, Layer 126B has several circuit features that are patterned on surface 126B. Surface 126B has terminals 140, 141, 142, 143, 144, and 145. Side surfaces 106 have edge terminals 160, 161, 162, 163, 164, and 165. The edge terminals are connected between the terminals on the top and bottom surfaces and provide terminals that wrap around the side, top and bottom surfaces.

Terminals 133, 143 and 163 form input port 31. Terminals 135, 142 and 165 form isolated port 34. Terminals 130, 140 and 160 form output port 33. Terminals 132, 142 and 162 form output port 32.

Layers 112-126 have several circuit features that are patterned on their top surfaces. Surface 112A has capacitor plates 201, 211, 221 and 231 and circuit lines 251 and 271. Surface 113A has capacitor plates 202, 212, 222 and 232 and circuit lines 261 and 281. Surface 114A has capacitor plates 203, 213, 223 and 233 and circuit lines 252 and 272. Surface 115A has capacitor plates 204, 214, 224 and 234 and circuit lines 262 and 282. Surface 116A has capacitor plates 205, 215, 225 and 235 and circuit lines 253 and 273. Surface 117A has capacitor plates 206, 216, 226 and 236 and circuit lines 263 and 283. Surface 118A has capacitor plates 207, 217, 227 and 237 and circuit lines 254 and 274. Surface 119A has capacitor plates 208, 218, 228 and 238 and circuit lines 264 and 284. Surface 120A has capacitor plates 209 and 239 and circuit lines 255 and 275. Surface 121A has circuit lines 265 and 285. Surface 122A has circuit lines 256 and 276. Surface 123A has circuit lines 266 and 286. Surface 124A has circuit lines 257 and 277. Surface 125A has circuit lines 267 and 287. Surface 126A has circuit lines 258 and 278.

The circuit lines are formed on the layers in a three-quarter circular or C-shape. The C-shaped circuit lines have an associated diameter. Circuit lines 251-258 are connected together on every other layer or alternate layers by vias 150. The connected circuit lines 251-258 form an inductor or winding 41 of transformer 40. Circuit lines 261-267 are connected together on every other layer or alternate layers by vias 150. The connected circuit lines 261-267 form an inductor or winding 42 of transformer 40. It is noted that the circuit lines are connected in a interleaved or alternate manner between layers. The connected circuit lines form a helix shape or helical structure. Alternating the circuit lines between the layers allows the lines or windings to be electro-magnetically coupled to each other and therefore function as a transformer.

Circuit lines 271-278 are connected together on every other layer or alternate layers by vias 150. The connected circuit lines 271-278 form an inductor or winding 46 of transformer 45. Circuit lines 281-287 are connected together on every other layer or alternate layers by vias 150. The connected circuit lines 281-287 form an inductor or winding 47 of transformer 45.

Circuit line 258 has an end connected to edge terminal 163. Circuit line 257 has an end connected to edge terminal 165. Circuit line 267 has an end connected to edge terminal 160. Circuit line 287 has an end connected to edge terminal 162.

Capacitor plates 201-209 are located adjacent each other on sequential layers. Capacitor plates 201-209 form capacitor 52. Capacitor plates 211-218 are located adjacent each other on sequential layers. Capacitor plates 211-218 form capacitor 50. Capacitor plates 221-228 are located adjacent each other on sequential layers. Between each capacitor plate is a layer of low temperature co-fired ceramic. Capacitor plates 221-228 form capacitor 51. Capacitor plates 231-239 are located adjacent each other on sequential layers. Capacitor plates 231-239 form capacitor 53.

Capacitor plates 212, 214 and 216 are connected to edge terminal 160. Capacitor plates 201, 203, 205, 207 and 209 are connected to edge terminal 161. Capacitor plates 221, 223, 225 and 227 are connected to edge terminal 162. Capacitor plates 211, 213, 215 and 217 are connected to edge terminal 163. Capacitor plates 231, 233, 235, 237 and 239 are connected to edge terminal 164. Capacitor plates 222, 224, 226 and 228 are connected to edge terminal 164.

The circuit features of the terminals, circuit lines and capacitor plates are formed by screening a thick film paste material and firing in an oven. First, the LTCC layers have via holes punched through the layer. The vias are then filled with a conductive material. Next, the circuit features are screened onto the layers. The capacitor plates and circuit lines are formed with a conductive material. The layers are then aligned and stacked on top of each other to form LTCC substrate 102. The LTCC structure 102 is then fired in an oven at approximately 900 degrees centigrade to form a unitary piece. The conductive material can be a silver metal paste.

After firing, the edge terminals 163, 164, 165, 166, 167 and 168 are screened onto side surfaces 106 and 107 using a conductive material and fired in an oven to produce the wrap around terminals.

Power splitter 100 is typically used by mounted to a printed circuit board (not shown) by using conventional soldering techniques. The bottom terminals 140, 141, 142, 143, 144 and 145 are soldered to corresponding electrical connections on the printed circuit board.

Two versions of power splitter 100 were built and tested for electrical performance. The first version was built to operate in the frequency range of 425 to 675 MHz. The second version was built to operate in the frequency range of 800 to 1400 MHz. All measurements were made at an RF level of −10 dBm. Several parameters of the versions were varied to obtain the desired electrical characteristics in each frequency range. The first and second versions varied the following dimensions in power splitter 100:

1. Circuit line widths.

2. Diameter of the circular transformers.

3. Thickness of the LTCC layers.

4. Capacitance of the multi-layer capacitors.

The fabricated power splitter had an overall size of 0.12 inches by 0.06 inches by 0.03 inches.

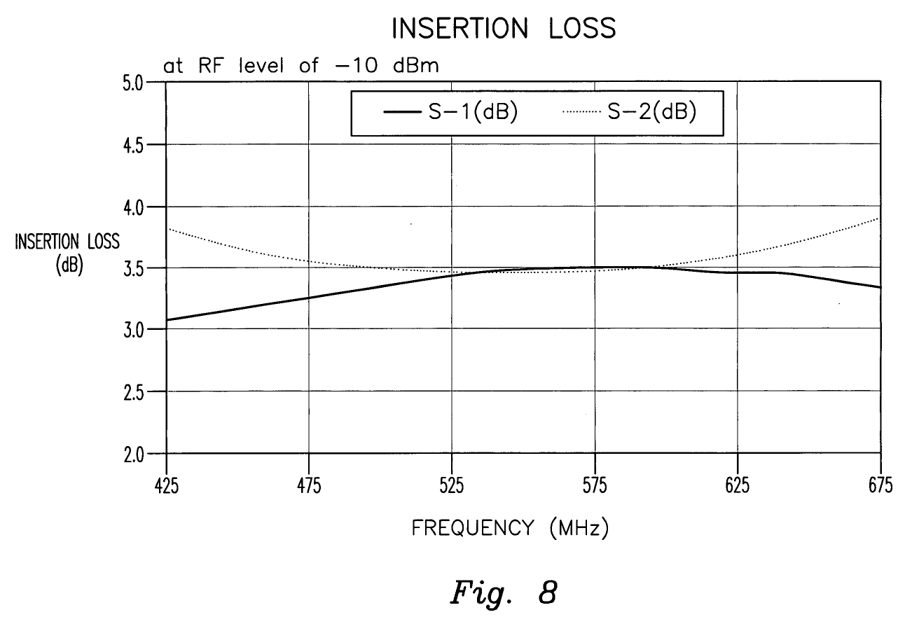

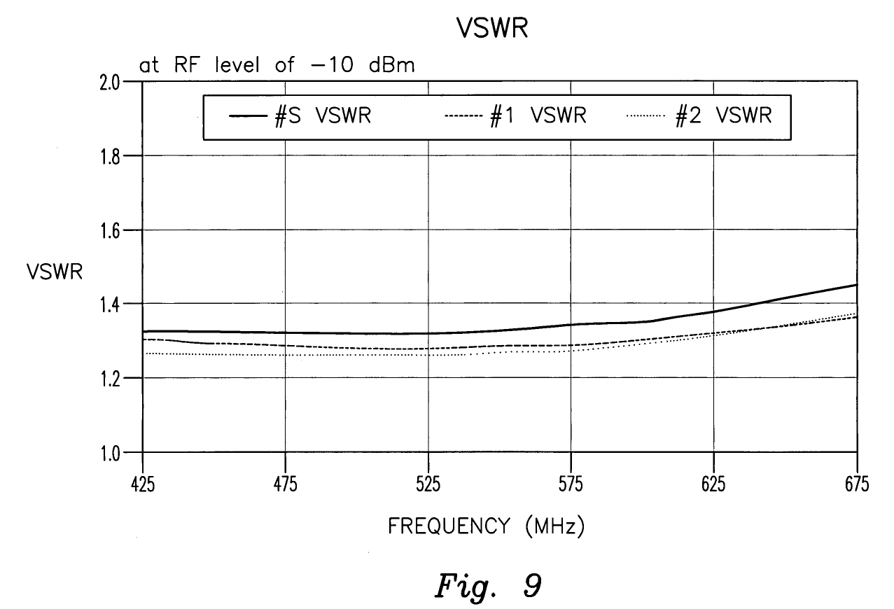

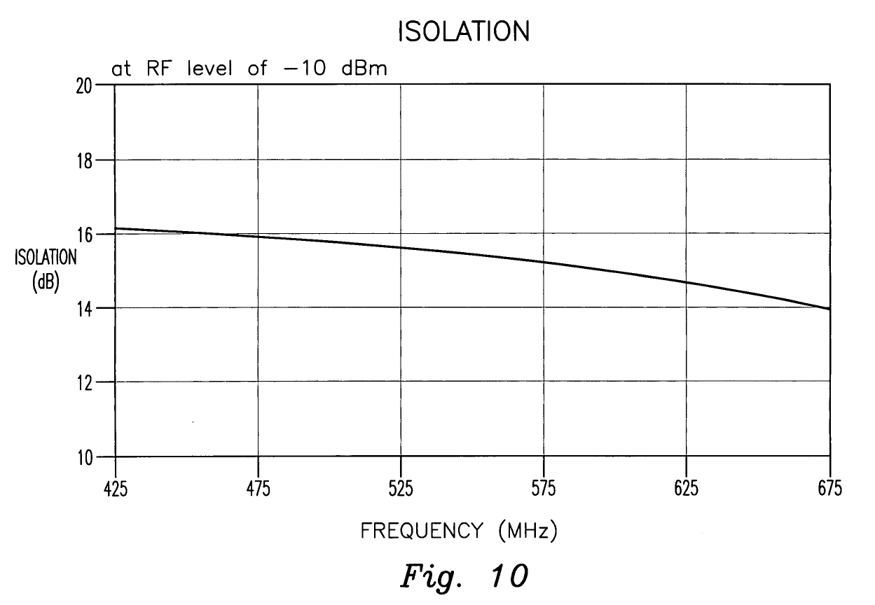

FIG. 8 shows a graph of insertion loss versus frequency for the first version of power splitter 100 over the frequency range of 425 to 675 MHz. FIG. 9 shows a graph of VSWR versus frequency over the frequency range of 425 to 675 MHz. FIG. 10 shows a graph of isolation versus frequency over the frequency range of 425 to 675 MHz.

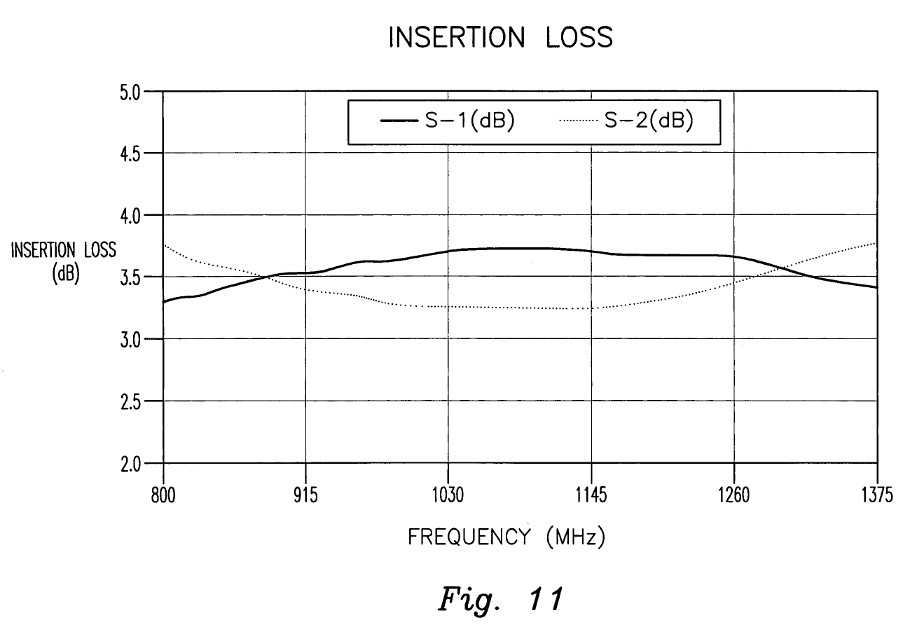

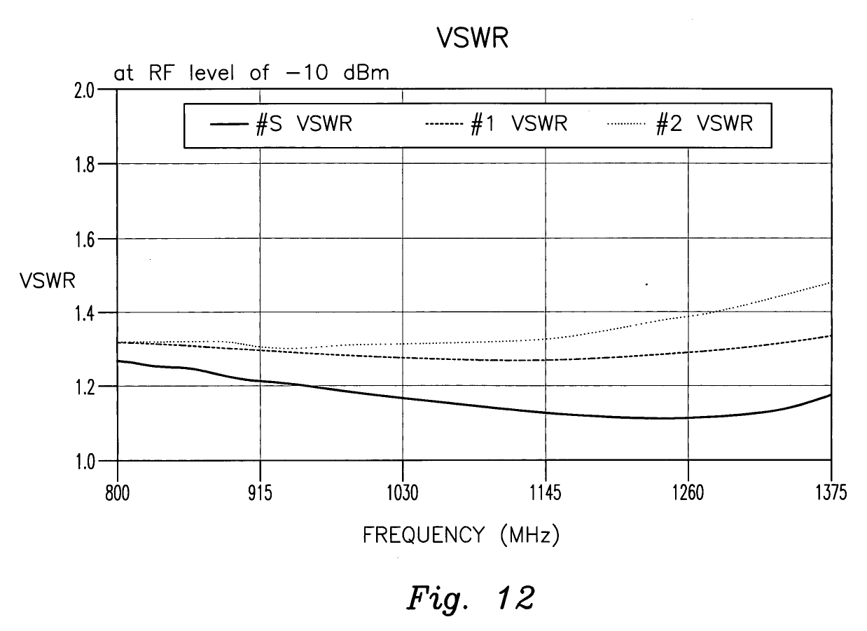

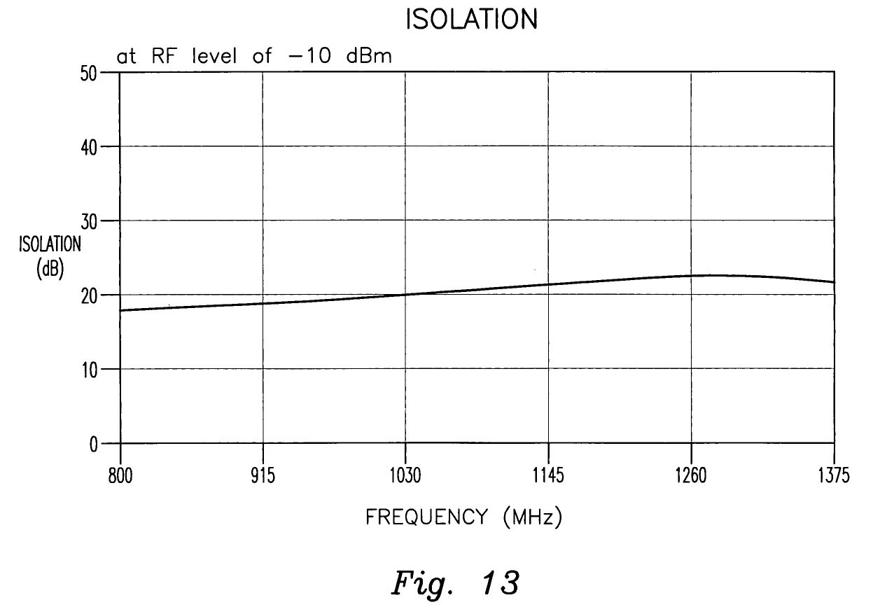

Turning now to FIGS. 11-13, the electrical performance of the second version of power splitter 100 over the frequency range of 800 to 1400 MHz is shown. FIG. 11 shows a graph of insertion loss versus frequency over the frequency range of 800 to 1400 MHz. FIG. 12 shows a graph of VSWR versus frequency over the frequency range of 800 to 1400 MHz. FIG. 13 shows a graph of isolation versus frequency over the frequency range of 800 to 1400 MHz. Both the first and second versions of power splitter 100 have good electrical performance over their respective frequency ranges.

The present invention has several advantages. The use of lumped element transformers and capacitors take up less space than the coupled transmission lines of the prior art, resulting in a smaller overall size for the power splitter. The fabricated power splitter had an overall size of 0.12 inches by 0.06 inches by 0.03 inches, which is ⅕ the size of previous low frequency power splitters operating between 100 MHz and 1 GHz. The small package size provides a savings of space on the assembled printed circuit board and allows for a faster assembly process at lower cost.

The use of the transformer windings implemented as helical interleaved circuit lines on alternating layers provides a compact transformer assembly.

While the invention was shown using sixteen LTCC layers, it is possible to use more or fewer LTCC layers.

While a 2-way power splitter 100 was shown, 4-way or 8-way power splitters can be fabricated using the same methodology as the present invention.

While the invention has been taught with specific reference to these embodiments, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the description. All changes that come within the meaning and range of equivalency of the claims are to be embraced within their scope.

What is claimed is:

1. A power splitter comprising:
a low temperature co-fired ceramic substrate having a top surface, a bottom surface and a plurality of side surfaces, the substrate further having a plurality of layers including a plurality of inner layers;
a first transformer formed by a first and second circuit line formed on the inner layers, the first circuit line interconnected between the layers by a first via and the second circuit line interconnected between the layers by a second via; and
a second transformer formed by a third and fourth circuit line formed on the inner layers, the third circuit line interconnected between the layers by a third via and the fourth circuit line interconnected between the layers by a fourth via.

2. The power splitter according to claim 1, wherein the power splitter is a ninety degree power splitter.

3. The power splitter according to claim 1, wherein the inner layers further include a first set of layers and a second set of layers.

4. The power splitter according to claim 3 wherein the first circuit line is located on the first set of layers and the second circuit line is located on the second set of layers.

5. The power splitter according to claim 3 wherein the third circuit line is located on the first set of layers and the fourth circuit line is located on the second set of layers.

6. The power splitter according to claim 1 wherein the circuit lines form a partial circle on each of the inner layers.

7. The power splitter according to claim 1 wherein the first and second circuit lines are interleaved on alternate inner layers.

8. The power splitter according to claim 1 wherein the third and fourth circuit lines are interleaved on alternate inner layers.

9. A power splitter comprising:
a low temperature co-fired ceramic substrate having a top surface, a bottom surface and a plurality of side surfaces;
the substrate having a plurality of layers including a plurality of inner layers;
the inner layers having a first set of layers and a second set of layers, the first set of layers alternating with the second set of layers;
a first and third circuit line formed on the first set of layers, the first circuit line interconnected between the layers by a first via and the third circuit line interconnected between the layers by a third via; and
a second and fourth circuit line formed on the second set of layers, the second circuit line interconnected between the layers by a second via and the fourth circuit line interconnected between the layers by a fourth via.

10. The power splitter according to claim 9, wherein the power splitter is a ninety degree power splitter.

11. The power splitter according to claim 9, wherein the circuit lines are shaped in a partial circle on each of the inner layers.

12. The power splitter according to claim 9, wherein a plurality of capacitors are formed on the inner layers.

13. The power splitter according to claim 12, wherein each capacitor has a plurality of plates.

14. The power splitter according to claim 9, wherein the layers comprise sixteen layers.

15. The power splitter according to claim 9, wherein a plurality of terminals are formed on the top and bottom surfaces and are connected to the vias.

16. The power splitter according to claim 15, wherein the terminals wrap around the side surfaces.

17. The power splitter according to claim 15, wherein the first and third circuit lines are adjacent to each other on the first set of layers and the second and fourth circuit lines are adjacent to each other on the second set of layers.

18. A power splitter comprising:
an input port, a first and second output port and an isolated port;
a first transformer having a first and second winding, the first winding connected to the input port and the second winding connected to the isolated port;
a second transformer having a third and fourth winding, the third winding connected to the first output port and the fourth winding connected to the second output port;
the first winding further connected to the third winding;
the second winding further connected to the fourth winding;
a first capacitor connected between the input port and the isolated port;
a second capacitor connected between the output ports;
a third capacitor connected between a junction of the first winding and the third winding and ground; and
a fourth capacitor connected between a junction of the second winding and the fourth winding and ground.

19. The power splitter according to claim 18, wherein the overall size of the power splitter is less than 0.12 inches by 0.06 inches by 0.03 inches.
